(19) United States
(12) Patent Application Publication
(10) Pub. No.: US 2007/0070310 A1
(43) Pub. Date: Mar. 29, 2007

(54) Mobile projector for performing forward and backward scanning

(75) Inventors: Seung Won Ryu, Suwon-si (KR); In Jae Yeo, Yongin-si (KR); Kyu Bum Han, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/525,736

(22) Filed: Sep. 22, 2006

(30) Foreign Application Priority Data
Sep. 23, 2005 (KR) 10-2005-0088744

(51) Int. Cl. G03B 21/00; H04N 9/31; H04N 5/64

(52) U.S. Cl. 353/122; 348/744

(57) ABSTRACT

Disclosed herein is a mobile projector. The mobile projector includes an optical modulation system and a projection control unit. The optical modulation system includes an optical source system externally or internally mounted on or in a portable terminal for generating and radiating light, an illumination optical system for converting the light into linear incident light, a diffractive optical modulator for modulating the linear incident light into linear diffracted light in response to driving signals, a projection optical unit for projecting the linear diffracted light onto a screen, and a scanning unit for generating video by repeatedly performing first direction scanning and backward scanning on the linear diffracted light across the screen. The projection control unit is externally or internally mounted on or in the portable terminal, and receives video data from a first processor of the portable terminal, generates driving signals corresponding to the video data when the first direction scanning is performed and when the backward scanning is performed, and outputs the driving signals to the diffractive optical modulator of the optical modulation system.

### BACKGROUND OF THE INVENTION

1. Field of the Invention

The present invention relates to a mobile projector that is externally or internally mounted on or in a portable terminal, magnifies and projects light, and projects video images onto a screen while performing forward and backward scanning.

2. Description of the Related Art

Recently, with the rapid development of the electronic industry and information and communication technology, various types of textual and visual information is being processed using terminals, such as desktop Personal Computers (PCs), notebook PCs and mobile phones in almost all industries. In particular, with the increase of utilization of information via the Internet, mobile phones, in addition to desktop PCs and notebook PCs, are connected to the Internet and process information in conjunction with the Internet.

However, terminals, such as desktop PCs, notebook PCs and mobile phones are disadvantageous in that viewing ranges and readability are limited because monitors having specific dimensions are integrated with terminal bodies.

For example, Cathode Ray Tube (CRT) monitors, which are the display devices of desktop PCs, are disadvantageous in that the sizes thereof are limited, the volumes thereof are large and the weights thereof are heavy, the installation conditions thereof are bad because they require relatively high driving voltages, they are not suitable for portable use, and the viewing ranges thereof are limited to areas in front of them because the screens thereof generally face users.

Liquid Crystal Displays (LCDs), which are the display devices of notebook PCs, are disadvantageous in that the sizes of the screens thereof are limited compared to CRTs, and the viewing ranges of the screens are limited chiefly to ranges in front of viewers because the LCDs are integrated with notebook PCs.

Furthermore, LCDs, which are the display devices of mobile phones, are disadvantageous in that viewing ranges and information display areas are limited to small areas because the sizes of the screens thereof are very small. Therefore, the sizes of characters displayed are very small, therefore readability is inferior. In particular, in Internet mobile phones containing web browsers and connecting to the Internet, a display area for a unit frame is limited to a small area, so the entire Internet screen cannot be displayed.

Due to the above-described problems, the desktop PCs, the notebook PCs and the mobile phones are disadvantageous in that they are very inconvenient when a plurality of persons needs to view a display screen at the same time, and viewers cannot view display screens from locations beside or behind the display devices.

Although an LCD projector, which is connected to a desktop PC, a notebook PC or a mobile phone via a connector, provides an interface for the data in terminal data memory, and projects the data onto a screen via a Thin Film Transistor (TFT) LCD and a lens, is provided as a display device that is capable of solving the above-described problems, such an LCD projector employs a remote distance projection scheme, therefore the projector is problematic in that it requires a bright light source, the volume thereof is large, and it is difficult to carry the projector.

### SUMMARY OF THE INVENTION

Accordingly, the present invention has been made keeping in mind the above problems occurring in the prior art, and an object of the present invention is to provide a mobile projector, which generates a video image by modulating light, emitted from light sources, using an optical modulator, magnifies the generated video image, and projects the magnified video image on a screen while performing forward and backward scanning, thereby being capable of satisfying the requirements for small-sized portable terminals and low power consumption.

In order to accomplish the above object, the present invention provides a mobile projector, including an optical modulation system comprising an optical source system externally or internally mounted on or in a portable terminal for generating and radiating light, an illumination optical system for converting the light, radiated from the optical source system, into linear incident light, a diffractive optical modulator for modulating the linear incident light, incident from the illumination optical system, into linear diffracted light in response to driving signals, a projection optical unit for projecting the linear diffracted light, emitted from the diffractive optical modulator, onto a screen, and a scanning unit for generating video by repeatedly performing first direction scanning and backward scanning on the linear diffracted light, emitted from the diffractive optical modulator, across the screen; and a projection control unit externally or internally mounted on or in the portable terminal for receiving video data from a first processor of the portable terminal, generating driving signals corresponding to the video data when the first direction scanning is performed and when the backward scanning is performed, and outputting the driving signals to the diffractive optical modulator of the optical modulation system.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a portable terminal in which a mobile projector for performing forward and backward scanning according to an embodiment of the present invention is installed;

FIG. 2 is a block diagram illustrating the internal construction of the projection driving unit of FIG. 1;

FIG. 3 is a perspective view of the diffractive optical modulator of FIG. 1;

FIG. 4 is a plan view of the open hole-based diffractive optical modulator of FIG. 3;

FIG. 5 is a detailed diagram of the scanning unit of FIG. 1;

FIG. 6 is a view showing a time-to-distance scanner trajectory according to an embodiment of the present invention;

FIG. 7A is a view showing the structure of laterally arranged input video data in typical portable terminal applications, and FIG. 7B is a view showing the structure of vertically arranged video data; and

FIG. 8A is a view showing the structure of a frame of video data composed of 480×640 pixels, and FIG. 8B is a view showing the transposing of input video data from laterally arranged data to vertically arranged data.

### DESCRIPTION OF THE PREFERRED EMBODIMENTS

Reference now should be made to the accompanying drawings, in which the same reference numerals are used throughout the different drawings to designate the same or similar components.

With reference to the accompanying drawings, preferred embodiments of the present invention are described in detail below.

Although, in the present specification, the case where a mobile projector is used in a mobile phone is described, the present invention is not limited thereto, but the mobile projector may be used in portable devices, including a Personal Digital Assistant (PDA), Moving Picture Experts Group Audio Layer-3 (MP3) unit, a wristwatch, a laptop computer, and a camera. Accordingly, the term “portable terminal” includes the above-described portable devices and devices similar thereto.

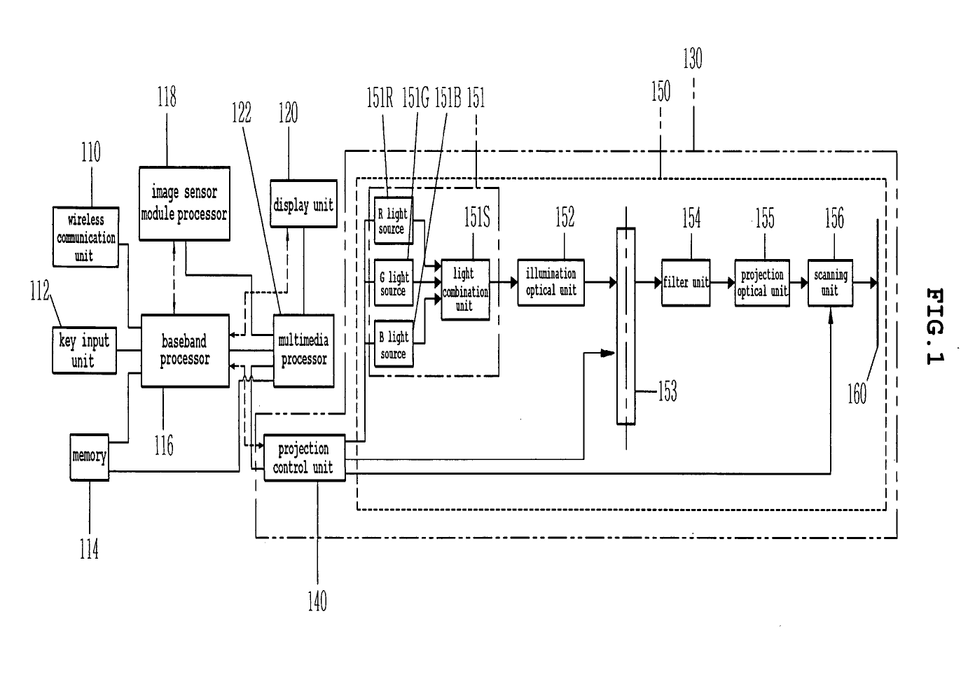

FIG. 1 is a block diagram of a portable terminal in which a mobile projector 130 for performing forward and backward scanning according to an embodiment of the present invention is installed.

As shown in FIG. 1, the portable terminal, in which a mobile projector 130 for performing forward and backward scanning according to the embodiment of the present invention is installed, includes a wireless communication unit 110 for performing wireless communication, a key input unit 112 for allowing a user to input information, memory 114 for storing video data, a baseband processor 116 for controlling a multimedia processor 122 so that video is displayed on a display unit 120, or is scanned in forward and backward directions and projected on a screen 160, an image sensor module processor 118 for processing video input from a provided camera and sending the processed video data to the multimedia processor 122, a display unit 120 for receiving video data from the multimedia processor 122 and displaying video on a screen based on the received video data, the multimedia processor 122 for storing video, input from the image sensor module processor 118, in the memory 114 or transmitting the video to the display unit 120 or a projection control unit 140 to be displayed or projected, and when a video display signal signal/video projection signal is input from the baseband processor 116, reading video data from the memory 114, transmitting the video data to the display unit 120 or projection control unit 140, and displaying the video data on a Liquid Crystal Display (LCD) display or the like or projecting the video data while performing forward and backward scanning, and the mobile projector 130 for generating video based on the video data received from the multimedia processor 122, magnifying the generated video and projecting the magnified video on the screen 160. In this case, the multimedia processor 122 and the baseband processor 116 are collectively referred to as a “terminal control system.” Meanwhile, if the portable terminal is not a mobile phone, the baseband processor 116 may be replaced with one of other types of processors. That is, the term “baseband processor” includes other types of processes that can be used in the above-described other types of portable terminals.

Meanwhile, the dotted lines of FIG. 1 indicate the flows of signals such as video data in the case where the multimedia processor 122 is not provided. Referring to FIG. 1, in the case where the multimedia processor 122 is not provided, the image sensor module processor 118 processes video data input from the camera, and sends the processed video data to the baseband processor 116. The display unit 120 receives the video data from the baseband processor 116, and displays video on the screen based on the video data. The baseband processor 116 stores the video input from the image sensor module processor 118 in the memory 114, and sends the video to the display unit 120 or the projection control unit 140 so that it is displayed or projected. Moreover, the baseband processor 116 reads the video data from the memory 114, and sends the video data to the display unit 120 or the projection control unit 140 so that the video data is displayed on an LCD display or the like or projected onto the screen 160 while forward and backward scanning is performed.

In this case, the mobile projector 130 for performing forward and backward scanning according to the present invention includes a projection control unit 140 for controlling an optical modulation system 150 so that the optical modulation system 150 generates video based on input video data when a projection signal and the video data are input in the case where the multimedia processor 122 is not provided (in the case where the multimedia processor 122 is not provided, the baseband processor 116 performs the same function as the multimedia processor 122), and also includes the optical modulation system 150 for generating video in response to the projection signal and the video data input from the projection control unit 140 and projecting the generated video onto the screen 160 while performing forward and backward scanning.

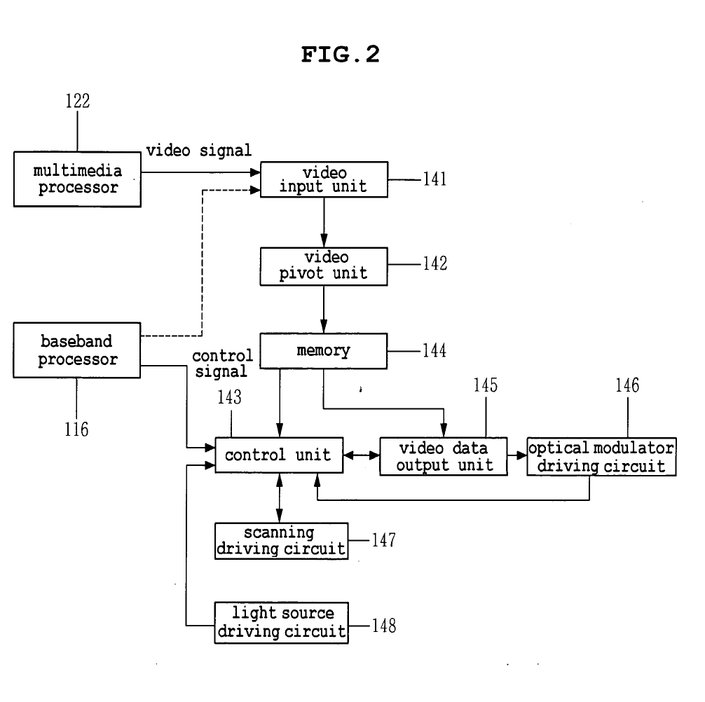

The projection control unit 140 includes a video input unit 141, a video pivot unit 142, a control unit 143, memory 144, a video data output unit 145, an optical modulator driving circuit 146, a scanning driving circuit 147, and an optical source driving circuit 148, which are shown in FIG. 2.

The optical modulation system 150 includes an optical source system 151 for generating and emitting RGB light, an illumination optical system 152 for allowing the light, emitted from the optical source system 152, to enter the diffractive optical modulator 153, a diffractive optical modulator 153 for generating a video image by diffracting the light incident from the incident illumination optical system 152 (That is, the illumination optical system 152 generates diffracted light having a plurality of diffraction orders by diffracting the incident light. In this case, the video image is generated using diffracted light having one or more diffraction orders, which belongs to the diffracted light having the plurality of diffraction orders), a filter unit 154 for passing only the diffracted light having one or more diffraction orders, which belongs to the diffracted light having the plurality of diffraction orders, therethrough, a projection optical unit 155 for projecting video composed of the diffracted light passed through the filter unit 154, and a scanning unit 156 for scanning video through the screen 160 in forward and backward directions.

The functions and operation of the respective elements of the optical modulation system 150 are described below.

The optical source system 151 of the optical modulation optical source system 150 includes a plurality of optical sources (for example, a red light source 151R, a green light source 151G, and a blue light source 151B) and condenser units 151S, and condenses and emits light 151S. Meanwhile, when the optical source system 151 emits the light from the red light source 151R, the green light source 151G and the blue light source 151B in a time division fashion in the case where a single panel-type system, like that of the embodiment of the present invention, is used, that is, in the case where a single diffractive optical modulator 153 is used, there is no need to provide a separate device that has a color wheel (a device capable of temporally dividing a multi-beam according to color; not shown) and temporally divides a multi-beam according to color in front of or behind the diffractive optical modulator 153. Of course, when the optical source system 151 emits the light of a plurality of light sources in a multi-beam form, that is, when the optical source system 151 emits a multi-beam without time division, there is a need to provide a device that has a color wheel (not shown) and can temporally divide a multi-beam according to color, in front of or behind the diffractive optical modulator 153.

In this case, the condenser unit 151S may be constructed using a single reflective mirror and two dichroic mirrors when, for example, the red light source 151R, the green light source 151G and the blue light source 151B are used. As a result, blue light, green light and red light are condensed into a multi-beam, therefore a single illumination system can be constructed.

Thereafter, the illumination optical system 152 converts the light, emitted from the optical source system 151, into linear parallel light, and allows the linear parallel light to enter the diffractive optical modulator 153.

When the linear parallel light is incident from the illumination optical system 152, the diffractive optical modulator 153 generates diffracted light having a plurality of diffraction orders by performing optical modulation on the incident light incident under the control of the optical modulator driving circuit 146 of the projection control unit 140, and then generates video (in this case, video may be generated using diffracted light having one or more diffraction orders, which belongs to the diffracted light having a plurality of diffraction orders).

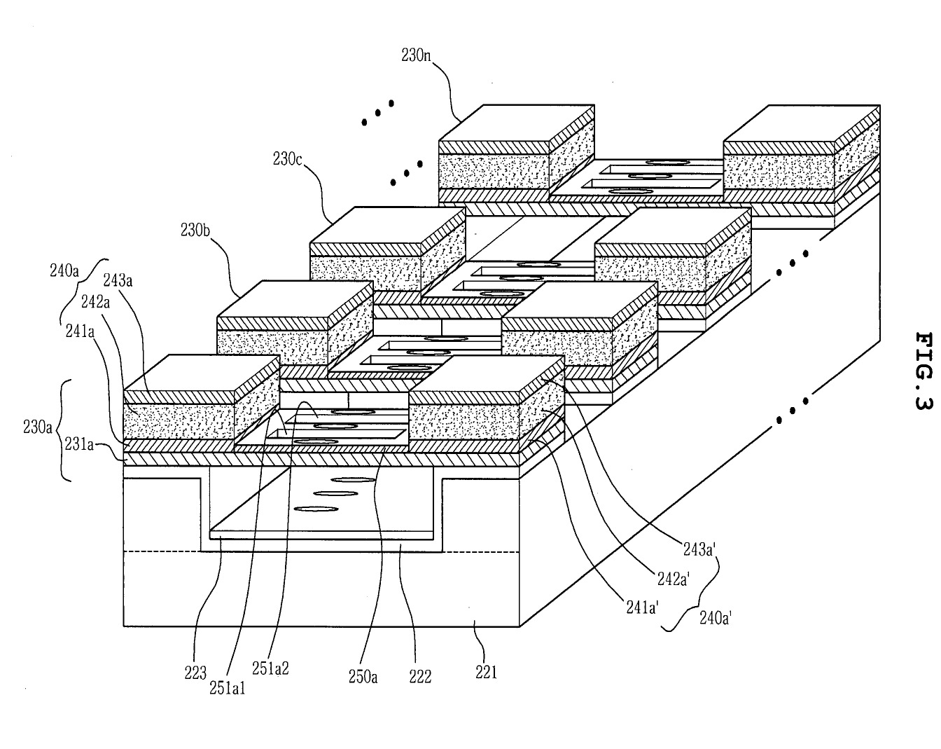

An example of the diffractive optical modulator 153 used herein is illustrated in FIG. 3. FIG. 3 shows an open hole-based diffractive optical modulator. Referring to FIG. 3, the open hole-based diffraction optical modulator includes a silicon substrate 221, an insulation layer 222, a lower reflection part 223, and a plurality of actuation elements 230a to 230n.

In this case, the lower reflection part 223 is deposited on the top of the silicon substrate 221, and reflects incident light. The lower reflection part 223 may be made of metal, such as Al, Pt, Cr, or Ag.

An actuation element 230a (although only the actuation element 230a is described herein, the remaining actuation elements have the same construction and operation) has a ribbon shape. The actuation element 230a includes a lower support 231a, both sides of the bottom of which are attached to regions beside the depressed portion of the silicon substrate 221, so that the central portion of the lower support 231a can be spaced apart from the depressed portion of the silicon substrate 221.

Piezoelectric layers 240a and 240a′ are formed on both sides of the lower support 231a. The actuation force of the actuation elements 230a is provided by the contraction and expansion of the piezoelectric layers 240a and 240a′.

Each of the piezoelectric layers 240a and 240a′ includes a lower electrode layer 241a or 241a′ configured to provide a piezoelectric voltage, a piezoelectric material layer 242a or 242a′ formed on the lower electrode layer 241a or 242a′ and configured to contract and expand and generate vertical actuation force when voltages are applied to both surfaces thereof, and a upper electrode layer 243a or 243a′ formed on the piezoelectric material layer 242a or 242a′ and configured to provide a piezoelectric voltage to the piezoelectric material layer 242a or 242a′. When voltages are applied to the upper electrode layers 243a and 243a′ and the lower electrode layers 241a and 242a′, the piezoelectric material layers 242a and 242a′ contract and expand, thus causing the vertical movement of the lower support 231a.

Meanwhile, an upper reflection part 250a is deposited on the center portion of the top of the lower support 231a, and includes a plurality of open holes 251a1 and 251a2.

The open holes 251a1 and 251a2 allow light, incident on the actuation element 230a, to pass therethrough and be incident on the portions of the lower reflection part 223 corresponding to the locations of the open holes 251a1 and 251a2, therefore the reflected light, which is reflected by the lower reflection part 223, and the reflected light, which is reflected by the upper reflection part 250a, form diffracted light.

The incident light, which passes through the portions where the open holes 251a1 and 251a2 of the upper reflection part 250a are formed, can be incident on the corresponding portions of the lower reflection part 223. When the distance between the upper reflection part 250a and the lower reflection part 223 is an odd multiple of λ/4, maximally diffracted light can be generated.

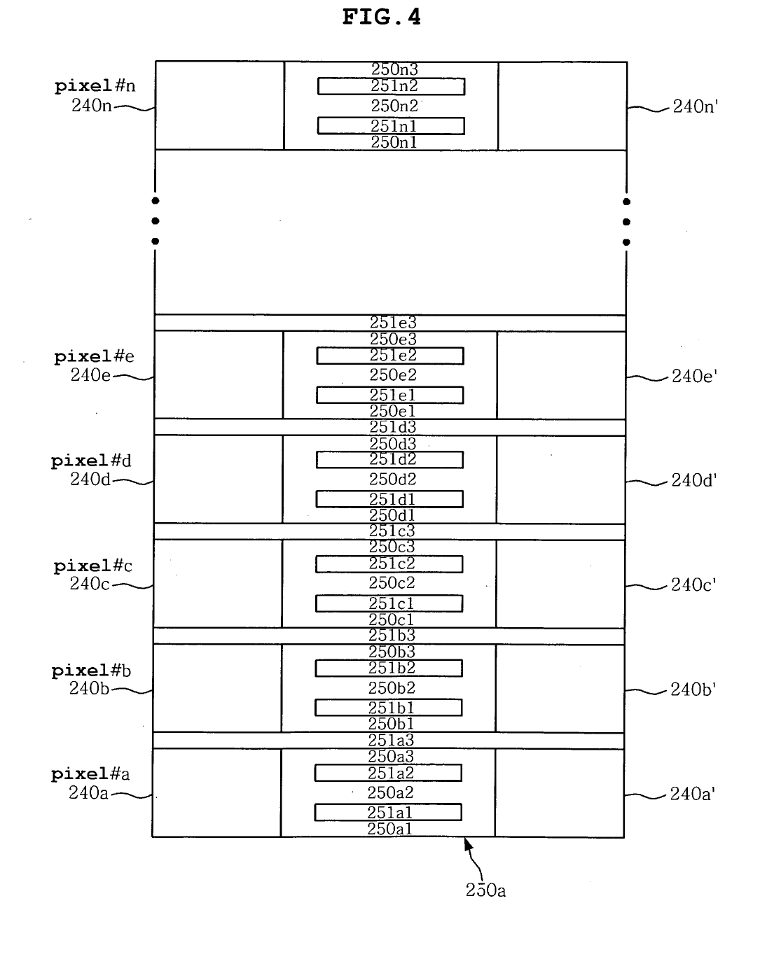

In this case, a single upper reflection part 250a and a corresponding lower reflection part 223 may form a scanning diffraction point light beam that is used to form a pixel of the video formed on the screen. In more detail, with reference to FIG. 4, the diffractive optical modulator 153 includes n upper reflection parts 250a to 250n that respectively correspond to the pixels a, b, c, d, e, . . . , n of the video formed on the screen 160. With reference to a single reflection part 240a, the diffractive optical modulator 153 allows the reflected light, which is reflected by the reflective surfaces 250a1, 250a2 and 250a3 of the upper reflection part 250a, and the reflected light, which passes through the open holes 251a1, 251a2 and 251a3 (in this case, reference 251a3 refers to a space between the upper reflection part 250a and another adjacent upper reflection part 250b) and is reflected by the lower reflection part 223, form diffracted light. The diffracted light is a scanning diffraction point light beam that corresponds to a pixel of the video formed on the screen 160.

That is, each of the upper reflection parts 250a to 250n, along with the reflective surface of a corresponding lower reflection part 223, forms a scanning diffraction point light beam that corresponds to a pixel of the video formed on the screen 160. Such a plurality of scanning diffraction point light beams is aligned and forms a scan line (in this case, the scan line is assumed to be composed of n scanning diffraction point light beams that respectively correspond to n pixels).

Meanwhile, the filter unit 154 is composed of, for example, a Fourier lens and a dichroic filter, and divides the diffracted light according to diffraction order and passes diffracted light having a desired diffraction order.

The projection optical unit 155 magnifies and projects video. The scanning unit 156 scans the incident diffracted light across the screen 160, so video is generated on the screen 160 and can be viewed by a viewer.

At this time, the scanning unit 156 generates two-dimensional video by scanning a scan line, composed of diffracted light having a plurality of scanning diffracted light beams passed through the filter unit 154, on the screen 160 in forward and backward directions.

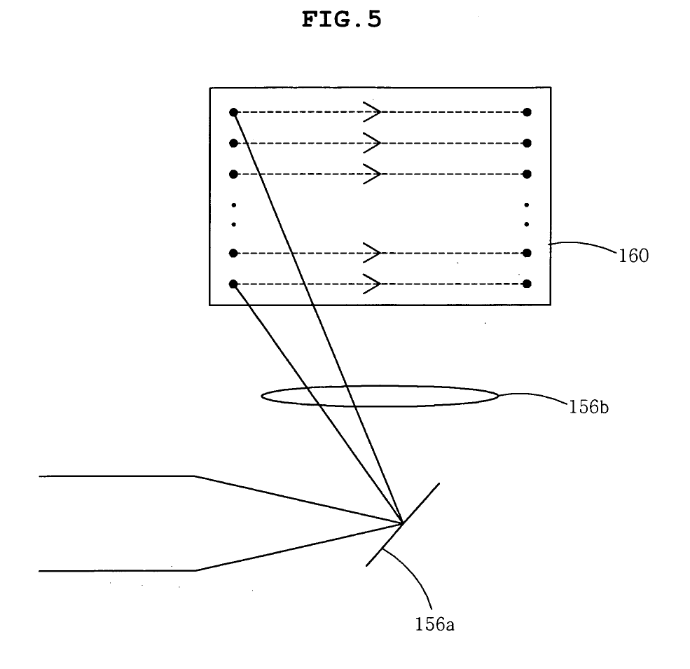

The scanning unit 156, as illustrated in FIG. 5, includes a scanner 156a and a projection lens 156b, and projects incident diffracted light onto the screen 160.

In this case, the scanner 156a is an X scanning mirror, and functions to scan an incident line image across the screen 160 in the direction from the left to the right, to perform scanning in the direction from the right to the left and to repeat the above-described operations, under the control of the scanning driving circuit 147 of the projection control unit 140.

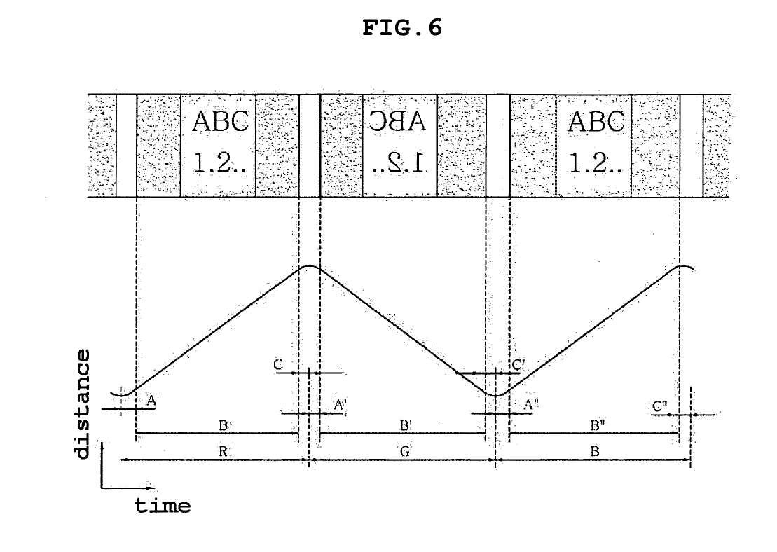

For example, as illustrated in the time-to-distance scanner trajectory of FIG. 6, a single color image composed of red, green and blue colors is realized by scanning a red color scan line when forward scanning is performed first by the scanner 156a in the direction from the left to the right, scanning a green color scan line across the screen 160 when backward scanning is performed in the direction from the right to the left, and scanning a blue color scan line on the screen 160 when forward scanning is performed in the direction from the left to the right. Of course, when the scanner 156a scans a red color scan line in the backward direction, scans a green color scan line in the forward direction and scans a blue color scan line in the backward direction, another color image composed of red, green and blue colors is realized. When the above-described operations are repeated, a moving image can be displayed.

The time-to-distance scanner trajectory of FIG. 6 is additionally described below. The time-to-distance scanner trajectory may be divided into an R interval, a G interval and a B interval. The R interval in turn may be divided into intervals A, B and C, the G interval in turn may be divided into A′, B′ and C′, and the B interval in turn may be divided into intervals A″, B″ and C″.

In this case, the R interval is a forward scan interval, the G interval is a backward scan interval, and the B interval is a forward scan interval.

In the R interval, the interval A is a scanning preparation interval, the B interval is a forward scanning interval, in which a scan line is displayed across the screen, and the C interval is an idle interval.

In the G interval, the interval A′ is a scanning preparation interval, the B′ interval is a backward scanning interval, in which a scan line—in this case, the scan line is a scan line having video information—is displayed across the screen, and the C′ interval is an idle interval.

In the B interval, the interval A″ is a scanning preparation interval, the B″ interval is a second forward scanning interval, in which a scan line is displayed across the screen, and the C″ interval is an idle interval.

If video information is contained in scan lines when backward scanning is performed as well as when forward scanning is performed, a screen that does not hinder humans' perception can be constructed, even if, in the present invention, scanning is performed at about 90 Hz.

Meanwhile, the diffracted light generated by the diffractive optical modulator 153 has a plurality of diffraction orders. When 0th-order diffracted light is used, high output can be generated using low power and power consumption is reduced, therefore the 0th-order diffracted light is suitable for portable terminals operating at low power. Furthermore, when 0th-order diffracted light is used as the diffracted light generated by the diffractive optical modulator 153, the diffracted light is not diffused, unlike +1st-order diffracted light and −1st-order diffracted light. Therefore, a large lens system, which is used to condense diffracted light when +1st-order diffracted light and −1st-order diffracted light are used, is not necessary, so the implementation of a small system can be achieved.

Moreover, since 0th-order diffracted light has a large depth of focus compared to +1st-order diffracted light or −1st-order diffracted light, the 0th-order diffracted light is suitable for use in portable terminals the screens 160 of which are not fixed. In this case, the term “depth of focus” refers to information indicating the distance along the optical axis over which the image is in focus. Since 0th-order diffracted light is a single light beam, 0th-order diffracted light has a greater depth of focus than the depth of focus of diffracted light having diffraction orders larger than a 0th diffraction order for which +order diffracted light and −order diffracted light are condensed and used. That is, in the case where diffracted light having diffraction orders larger than a 0th diffraction order is used, +order diffracted light and −order diffracted light form a focus while crossing each other, the depth of focus is low. Accordingly, in applications in which screens are not fixed, but users optionally set screens and adjust focus using their naked eyes, unlike portable terminals, the depth of focus needs to be large, and 0th-order diffracted light fulfills this need.

Although the above-described optical modulation system 150 has been described as generating video images using a single diffractive optical modulator 153, video images may be generated using three diffractive optical modulators that are separated for respective colors (which is referred to as a three panel scheme). In this case, three illumination systems are additionally required, and a color combination system is additionally required behind the diffractive optical modulator.

Meanwhile, the video input unit 141 of the projection control unit 140 receives video data from the multimedia processor 122, and directly receives video data from the baseband processor 116 in the case where the multimedia processor 122 is not provided.

The video pivot unit 142 performs a data transpose of converting laterally arranged video data into vertically arranged data, thereby converting laterally input video data into vertically arranged video data and storing the vertically arranged video data in the memory 144. The reason why a data transpose is required in the video pivot unit 142 is that a scan line emitted from the diffractive optical modulator 153 is composed of vertically arranged scanning diffraction point light beams corresponding to 480 pixels, therefore display is required to be performed through lateral scanning.

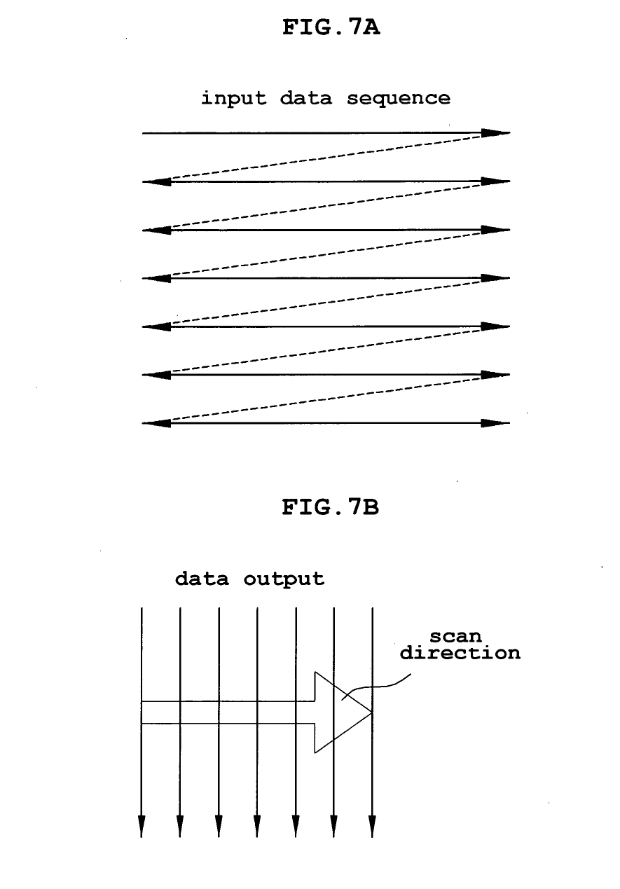

That is, as shown in FIG. 7A, standard video data is arranged in a lateral direction. However, since the diffractive optical modulator 153, as shown in FIG. 4, has a plurality of actuation elements 230a to 230n arranged in a vertical direction, it is adapted to display a plurality of pieces of video data while scanning the video data in a lateral direction.

Accordingly, in order to form a frame of video, which is composed of 480×640 pixels, using the diffractive optical modulator 153 by scanning a scan line, 480 pieces of vertically arranged data are required.

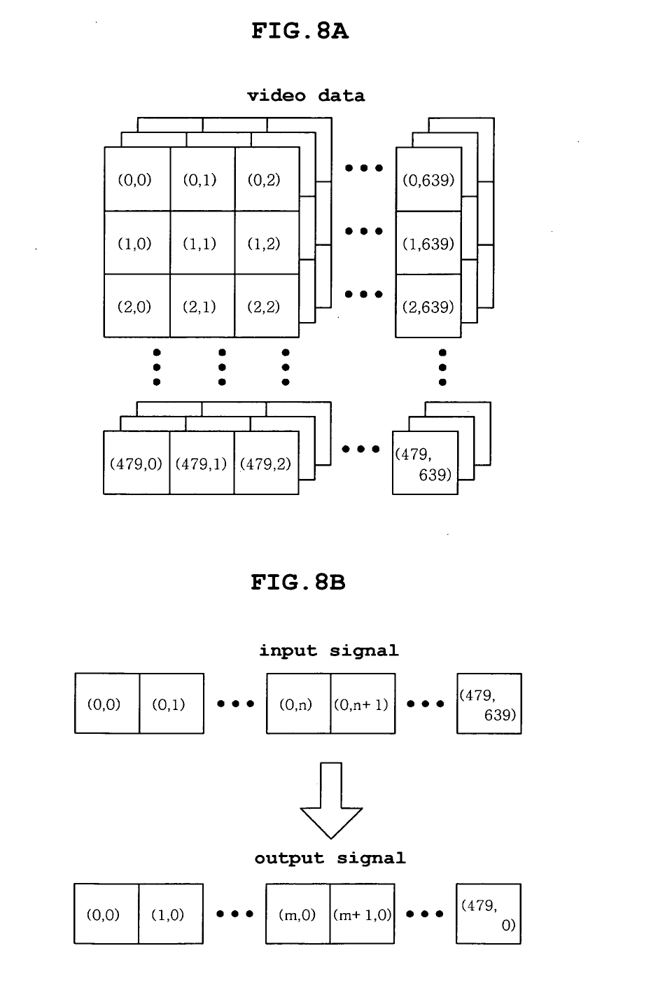

In other words, FIG. 8A illustrates the structure of a frame of video data that is composed of 480×640 pixels. The video data shown in FIG. 8A is input from the outside in a lateral direction in the sequence of 0,0, 0,1, 0,2, 0,3, . . . .

However, since 480 pieces of vertically arranged data are required to generate a frame of video data using the diffractive optical modulator 153, the input video data, as shown in FIG. 8B, must be transposed from laterally arranged video data to vertically arranged video data.

The video data output unit 145, during forward scanning, sequentially reads the video data, transposed by the video pivot unit 142 and stored in the memory 144, from the first column to the last column and outputs the read video data, and, during backward scanning, reads the transposed video data, stored in the memory 144, from the last column to the first column in reverse direction and outputs the read video data. By doing so, video formed on the screen 118 can be correctly generated without being reversed when the backward scanning is performed.

In response to the video data output from the video data output unit 145, the optical modulator driving circuit 146 drives the diffractive optical modulator 153, modulates incident light, and forms diffracted light having video information.

That is, in the driving of the diffractive optical modulator 153, the optical modulator driving circuit 146 drives the diffractive optical modulator 153, modulates incident light, and forms diffracted light having video information, during backward scanning as well as forward scanning.

The optical source driving circuit 148 selectively provides power laser light sources 106R, 106G and 106B. The scanning driving circuit 147 controls the scanner 156a of the scanning unit 156 so that forward scanning and backward scanning are sequentially performed. The scanning driving circuit 147 preferably sets the speed at which a scan line passes through any point of the screen 160 for forward scanning to equal the speed at which the scan line passes through the same point of the screen 160 during backward scanning.

Of course, the scanning driving circuit 147 may cause the speed at which a scan line passes through any point of the screen 160 for forward scanning to differ from the speed at which the scan line passes through the same point of the screen 160 during backward scanning.

As described above, according to the present invention, when a projector internally or externally mounted in or on a portable terminal is implemented using the optical modulator, a small-sized projector can be implemented, therefore the demand for a small-sized portable terminal can be met.

Furthermore, according to the present invention, since a low power diffractive optical modulator is used, the demand for low power consumption can be met.

Furthermore, according to the present invention, since temporal optical efficiency can be increased, brightness can be increased using the same light source and a low-power light source can be used to achieve the same brightness.

That is, according to the present invention, the present invention enables 94˜96% effective scanning, in comparison with the existing 75%˜85% effective scanning.

Furthermore, according to the present invention, since the maximum driving acceleration of the scanner can be decreased, the power consumption of the scanner driver can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile projector, comprising:
an optical modulation system comprising an optical source system externally or internally mounted on or in a portable terminal for generating and radiating light, an illumination optical system for converting the light, radiated from the optical source system, into linear incident light, a diffractive optical modulator for modulating the linear incident light, incident from the illumination optical system, into linear diffracted light in response to driving signals, a projection optical unit for projecting the linear diffracted light, emitted from the diffractive optical modulator, onto a projection surface, and a scanning unit for generating a video display by repeatedly performing first direction scanning and backward scanning on the linear diffracted light, emitted from the diffractive optical modulator, across the projection surface; and
a projection control unit externally or internally mounted on or in the portable terminal for receiving video data from the portable terminal, generating driving signals corresponding to the video data when the first direction scanning is performed and when the backward scanning is performed, and outputting the driving signals to the diffractive optical modulator of the optical modulation system.

2. The mobile projector as set forth in claim 18, wherein the first processor of the portable terminal is a baseband processor.

3. The mobile projector as set forth in claim 18, wherein the first processor of the portable terminal is a multimedia processor.

4. The mobile projector as set forth in claim 1, wherein the optical modulation system and the projection control unit are integrally contained in the portable terminal.

5. The mobile projector as set forth in claim 1, wherein the optical modulation system and the projection control unit are electrically connected to the portable terminal using a connection jack, and are thus fabricated in an external form.

6. The mobile projector as set forth in claim 1, wherein the scanning unit comprises a scanner that generates video on the projection surface by performing the first direction scanning, performing the backward scanning, and repeating these operations.

7. The mobile projector as set forth in claim 6, wherein the projection control unit controls the scanner so that a speed at which the linear diffracted light passes through a specific point of the projection surface during the first direction scanning can be similar to a speed at which the diffracted light passes through the point of the scanner during the backward scanning.

8. The mobile projector as set forth in claim 1, wherein the projection control unit comprises:
a video input unit for receiving video data from the first processor of the portable terminal;
memory for storing the video data that is input from the video input unit;
a video data output unit for sequentially reading and outputting video data, input in an interval for the first direction scanning, from a first column to a last column, and sequentially reading and outputting video data, input in an interval for the backward scanning, from a last column to a first column; and
an optical modulator driving circuit for providing driving signals, based on the video signals output from the video data output unit, to the diffractive optical modulator.

9. The mobile projector as set forth in claim 8 wherein the projection control unit further comprises a video pivot unit that converts the laterally input video data into vertically arranged video data by performing a transpose of converting the laterally arranged video data, input from the video input unit, into vertically arranged data.

10. The mobile projector as set forth in claim 1, wherein the diffracted light, emitted by the diffractive optical modulator, is diffracted light having a plurality of diffraction orders;
further comprising a filter unit that is located behind the diffractive optical modulator and passes diffracted light having one or more desired diffraction orders, which belongs to the diffracted light having a plurality of diffraction orders, therethrough.

11. The mobile projector as set forth in claim 10, wherein the filter unit comprises:
a Fourier lens for dividing the diffracted light having a plurality of diffraction orders, emitted from the diffractive optical modulator, according to diffraction order; and
a filter for selecting diffracted light having one or more desired diffraction orders from among the diffracted light having a plurality of diffraction orders, which has passed through the Fourier lens, and passing the selected diffracted light therethrough.

12. The mobile projector as set forth in claim 1, wherein:
the optical source system comprise a red light source, a green light source, and a blue light source; and
the projection control unit comprises an optical source driving circuit for controlling the optical source system so that red light, green light and blue light can be sequentially emitted.

13. The mobile projector as set forth in claim 1, wherein:
the optical source system comprise a red light source, a green light source, and a blue light source; and
the projection control unit comprises an optical source driving circuit for controlling the optical source system so that red light, green light and blue light can be sequentially emitted;
further comprising a color wheel that is located behind the optical source system and allows the red light, the green light and the blue light to sequentially pass therethrough.

14. The mobile projector as set forth in claim 1, wherein the first direction is a horizontal direction relative to the projection surface.

15. The mobile projector as set forth in claim 1, wherein the first direction is a vertical direction of relative to the projection surface.

16. The mobile projector as set forth in claim 1, wherein the diffractive optical modulator comprises:
a substrate;
a plurality of first reflection parts configured such that the first reflection parts are arranged to form an array, the first reflection parts are supported by the substrate, center portions of the first reflection parts are spaced apart from the substrate and, thus, provide a space, wherein the first reflection parts comprise surfaces facing away from the substrate, said surfaces being reflective and, thus, reflect some of incident light, and at least one open hole is formed in each of the first reflection parts and, thus, passes some of the incident light therethrough;
a second reflection part located to be spaced apart from the first reflection parts and, thus, ensure a space between the substrate and the first reflection parts, and provided with a reflective surface that reflects light passed through and emitted from the open holes of the first reflection parts; and
a plurality of means for varying an amount of light, which is formed by the reflected light of the first reflection parts and the reflected light of the second reflection part, by moving a center portion of a corresponding first reflection part away from or close to the substrate in response to a driving signal when the driving signal is input from the display electronic system.

17. The mobile projector as set forth in claim 16, wherein the first reflection parts comprise a plurality of open holes that are arranged in a direction that crosses the substrate.

18. The mobile projector as set forth in claim 1, wherein the video data is received from a first processor of the portable terminal.
